(19) United States
(12) Patent Application Publication
(10) Pub. No.: US 2022/0374536 A1
(43) Pub. Date: Nov. 24, 2022

(54) METHOD, COMPUTER PROGRAM, MEMORY MEDIUM, MEMORY MEANS, AND SYSTEM FOR USING A JOINTLY UTILIZED MEMORY MEANS

(71) Applicant: Robert Bosch GmbH, Stuttgart (DE)

(72) Inventors: Christian Eltzschig, Berlin (DE); Dietrich Kroenke, Berlin (DE); Mathias Kraus, Berlin (DE); Matthias Killat, Berlin (DE); Michael Poehnl, Wurmberg (DE); Piotr Palka, Berlin (DE)

(21) Appl. No.: 17/765,037

(22) PCT Filed: Sep. 30, 2020
(86) PCT No.: PCT/EP2020/077397

§ 371 Date: May 27, 2022

(30) Foreign Application Priority Data
Oct. 4, 2019 (DE) 10 2019 215 298.8

(51) Int. Cl. G06F 21/62

(52) U.S. Cl. CPC G06F 21/6218

(57) ABSTRACT

A computer-implemented method for the usage of a jointly utilized memory medium by a user, in particular by a computer-implemented application. The jointly utilized memory medium is divided into at least one partition, each partition being assignable a right of use, in particular a write permission and/or a read permission, a plurality of user groups being assignable to the right of use, the user being a member of a user group, a usage of the jointly utilized memory medium by the user being prevented when the user accesses a first partition of the at least one partition and the user is not a member of one of the user groups assigned to the right of use corresponding to the access.

### FIELD

The present invention provides a computer-implemented method, a computer program, an electronic memory medium, a jointly utilized memory means, and a system.

### BACKGROUND INFORMATION

In systems on which large amounts of data are processed, copying the data is a costly matter, i.e., a process which sometimes requires a large portion of the available computing resources. In systems for driver assistance or for automated driving, for example, multiple gigabytes per second are processed. Therefore, valuable computing resources, for example, in the form of computing time, may be saved if copying of data is avoided as far as possible.

On systems having multiple computing cores or various contexts of the execution (for example, various tasks on an OSEK operating system), using a communication middleware to ensure the consistent transfer of data between concurrent parts of the applications is conventional. Users of a communication middleware are producers and consumers. Producers enter data in the communication middleware; this may take place via the filing of data in memories managed by the middleware. Consumers use the entered data; this may be carried out via the readout of the corresponding memory managed by the middleware.

To avoid copies, using a so-called “zero copy” approach is conventional, in particular for entering data. Communication middleware according to the “zero copy” approach typically proceeds in two steps. In a first step, the producer requests memory or memory means from the communication middleware. In a second step, the producer writes the data to be provided in the requested memory.

Typically, the possibilities for changing the entered data are lost for the producer with the entering of the data in the memory. This is because a subsequent change of the data may result in an undefined behavior of the communication system.

To implement a “zero copy” approach, filing the data in a jointly utilized memory means (shared memory) is conventional, which may be read and written by all producers and consumers (more generally: applications). This may result in both safety and security problems.

In the present case, a safety problem is understood, for example, to mean that an application writes on a memory area in an unplanned manner which was intended for another application and thus triggers an undesirable behavior.

In the present case, a security problem is understood, for example, to mean that an application intentionally and maliciously influences another application.

To solve these problems, using memory management units (MMU) is conventional, among other things. MMUs typically convert physical memory addresses to virtual addresses. An application may thus only access, i.e., read and write, among other things, the memory of another application with significant effort. This security mechanism is weakened by the shared memory means, since now all applications may retrieve this memory in their particular address space and thus have access to the memory.

### SUMMARY

The present invention provides a computer-implemented method for the usage of a jointly utilized memory means (memory medium) by a user, the jointly utilized memory means being divided in at least one partition, each partition being assignable a right of use, in particular a write permission and/or a read permission, the right of use being assignable to a plurality of user groups, the user being a member of a user group, a usage of the jointly utilized memory by the user being prevented when the user accesses a first partition of the at least one partition and the user is not a member of one of the user groups assigned the right of use corresponding to the access.

A user may be understood, among other things, as a computer-implemented application.

A right of use may be understood in the present case, among other things, as a write permission or a read permission.

A write permission may be understood in the present case to mean that the accessing user, for example, the computer-implemented application, may access the partition in such a way that the data stored in the partition are changed or are changed after the access.

A read permission may be understood in the present case to mean that the accessing user, for example, the computer-implemented application, may access the partition in such a way that the user may read or read out the data stored in the partition. The data contained in the partition are typically maintained during the read access and are unchanged after the access. If a user only has read permission, a change of the data contained in the partition by the accessing user is not possible. The operating system ensures this using appropriate means.

The method of the present invention offers the advantage that the access of applications to a jointly utilized memory means is thus restricted in that a configuration including multiple partitions of a jointly utilized memory is created, which defines individual access rights per application and in fact according to the belonging of the application to a corresponding group. The safety and security level of the system is thus increased, i.e., enhanced.

A further aspect of the present invention is a computer program which is configured to carry out all steps of the method according to the present invention.

A further aspect of the present invention is an electronic memory medium on which the computer program according to the present invention is stored.

A further aspect of the present invention is a jointly utilized memory means which is configured for use in a method according to the present invention.

According to one specific example embodiment of the memory means (i.e., memory medium), the memory means includes a partition, the assignment of a right of use of the partition and the assignment of a plurality of user groups to the right of use taking place via an access control list.

An Access Control List (ACL) may be understood in the present case as a list with the aid of which single-tier rights of use, among other things, write or read permissions, may be allocated to users or user groups. An ACL is typically managed in a system by a central service. The access control is typically carried out with the aid of the operating system as a function of the assigned rights of use according to the ACL.

A further aspect of the present invention is a system encompassing a jointly utilized memory means according to the specific embodiment of the present invention and a central service, the central service creating a partition for the memory means and managing the assignment of the right of use of the partition and the assignment of a plurality of user groups to the right of use with the aid of the access control list.

A central service may be understood in the present case as a service of the operating system or a service of a software system similar to an operating system.

One specific example embodiment of the present invention is explained hereinafter on the basis of the figures.

### BRIEF DESCRIPTION OF THE DRAWINGS

FIG. 1 shows a flowchart of one specific example embodiment of the method of the present invention.

FIG. 2 shows a block diagram of a system according to an example embodiment of the present invention.

### DETAILED DESCRIPTION OF EXAMPLE EMBODIMENTS

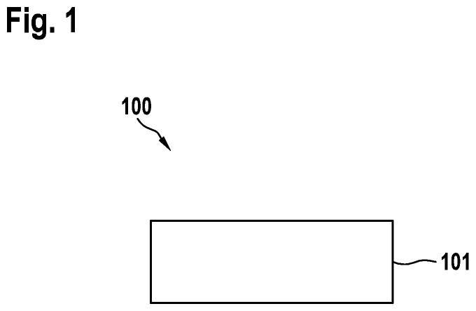

FIG. 1 shows a flowchart of one specific embodiment of the method of the present invention.

In step 101, a usage of the jointly utilized memory by a user is prevented. This prevention takes place since the user wished to access a partition of the jointly utilized memory although the user was not a member of the user group for which the respective usage of the first partition of the jointly utilized memory would be permissible.

Such a case may occur, for example, if, for example, a producer, for example, a fusion method for the fusion of sensor data of a plurality of surroundings sensors in an at least partially automated vehicle is to write data in a partition of a jointly utilized memory means for the zero copy (“zero copy” approach) provision to consumers, for example, to methods for vehicle lateral and longitudinal control, and is not a member of the required user group, which is assigned the corresponding right of use (write permission), for this usage (writing).

These rights of use may be allocated finely with the aid of an access control list (ACL) for individual partitions of a jointly utilized memory means. A central service, i.e., for example, a service of the operating system or a service in a software system similar to an operating system, may create the partitions and establish the rights of use via ACL. User groups are created which may access these partitions for writing and also groups which may only access these partitions for reading. It may thus be ensured that only users, for example, applications, which are in the particular write or read group may access the partition of the jointly utilized memory means. For all other users, for example, the operating system may prevent the access.

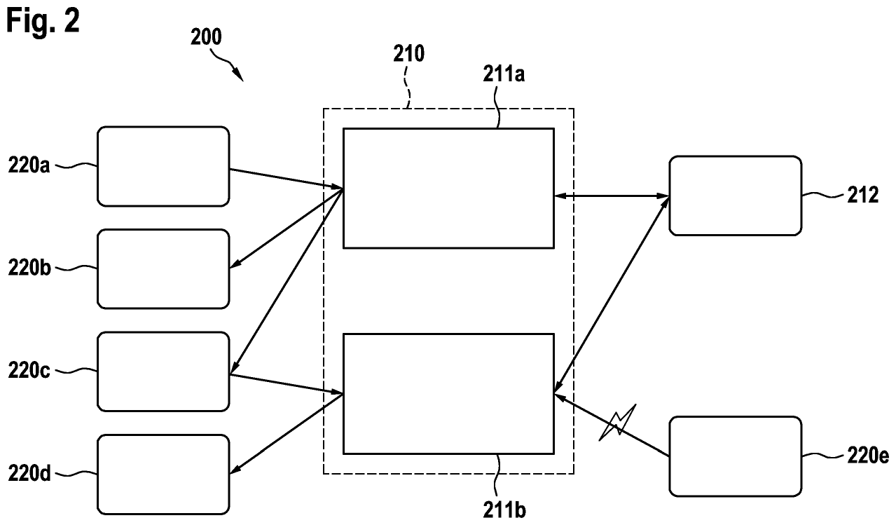

FIG. 2 shows a block diagram of a system 200 according to the present invention.

System 200 includes a jointly utilized memory 210. The memory is divided by a central service 212 into partitions 211a, 211b. Each partition includes rights of use, for example, write or read permissions. The particular rights may be assigned to no, one, or multiple user group(s). In the present example, partition 211a includes a write permission and a read permission. Group A is assigned the write permission of partition 211a. Group B is assigned the read permission. Furthermore, partition 211b also includes a read permission and a write permission. Group B is assigned the write permission of partition 211b. Group C is assigned the read permission. System 200 furthermore includes applications 220a through 220e. Each application may be assigned to no, one, or multiple user group(s). In the present example, the applications are each assigned to one user group. Application 220a is thus assigned to group A, application 220b to group B, application 220c to group B, application 220d to group C, application 220e to group D.

Applications 220a through 220e use jointly utilized memory means 210. The arrow directed toward the memory means represents a write access, the arrow directed toward the application represents a read access. The double arrow represents managed activities.

The accesses of applications 220a through 200d are not prevented, since the particular applications only in this way access partitions 211a, 211b, which correspond to their membership in the particular user group.

Application 220e accesses partition 211b to write. However, the write permission of partition 211b is assigned to group B. Application 220e is a member of group D, however. Therefore, according to the present invention, the usage of the partition of the jointly utilized memory by application 220e is prevented.

1-6. (canceled)

7. A computer-implemented method for usage of a jointly utilized memory device by a user, the user being a computer-implemented application, the method comprising:
dividing the jointly utilized memory device into at least one partition, each partition being assignable a right of use including a write permission and/or a read permission, a plurality of user groups being assignable to the right of use, the user being a member of a user group of the user groups; and
preventing the usage of the jointly utilized memory device by the user when the user accesses a first partition of the at least one partition and the user is not a member of one of the user groups assigned to the right of use corresponding to the access.

8. A non-transitory electronic memory medium on which is stored a computer program for usage of a jointly utilized memory device by a user, the user being a computer-implemented application, the computer program, when executed by a computer, causing the computer to perform:
dividing the jointly utilized memory device into at least one partition, each partition being assignable a right of use including a write permission and/or a read permission, a plurality of user groups being assignable to the right of use, a user being a member of a user group of the user groups; and
preventing the usage of the jointly utilized memory device by the user when the user accesses a first partition of the at least one partition and the user is not a member of one of the user groups assigned to the right of use corresponding to the access.

9. A jointly utilized memory device, the jointly utilized memory device being divided into at least one partition, each partition being assignable a right of use including a write permission and/or a read permission, a plurality of user groups being assignable to the right of use, wherein a user is prevented from using the jointly utilized memory device when the user accesses a first partition of the at least one partition and the user is not a member of one of the user groups assigned to the right of use corresponding to the access.

10. A memory device including a partition, an assignment of a right of use of the partition and an assignment of a right of use to a plurality of user groups taking place via an access control list.

11. A system, comprising:
a jointly utilized memory device; and
a central service, wherein the central service creates a partition for the memory device and manages an assignment of a right of use of the partition and the assignment of the right of use to a plurality of user groups using an access control list.
